(19) United States
(12) Patent Application Publication
(10) Pub. No.: US 2014/0213400 A1
(43) Pub. Date: Jul. 31, 2014

(54) BELT DRIVE SYSTEM

(71) Applicant: Juergen Hallen, Aachen (DE)

(72) Inventor: Juergen Hallen, Aachen (DE)

(21) Appl. No.: 13/755,102

(22) Filed: Jan. 31, 2013

(51) Int. Cl. F16H 7/12

(52) U.S. Cl. CPC F16H 7/12
USPC 474/135

(57) ABSTRACT

A belt system comprising a driver pulley, a driven pulley, a belt trained between the driver pulley and the driven pulley, a belt tensioning device engaged with the belt, a first idler engaged with the belt between the driver pulley and the driven pulley, a second idler engaged with the belt, the second idler engaged with the belt span immediately upstream of the driver pulley, the second idler comprising an arm journalled to a base, the arm urged to load the belt by a torsion spring, the arm having an effective length of less than 6 mm, and the torsion spring having a spring rate of approximately 0.128 mm/deg.

### FIELD OF THE INVENTION

The invention relates to a belt drive system, and more particularly, to a belt drive system having a tensioner, an idler, and a short effective length arm idler engaging the belt immediately preceding the driver pulley.

### BACKGROUND OF THE INVENTION

Mechanical tensioners are widely used in automobile engines to control belt tensions of accessory belt drives. Friction damping, force or torque, is usually utilized in a tensioner to control tensioner arm motion and vibration of the belt drive system. A belt drive with a high vibration level will require high damping from the tensioner to prevent belt slip, noise, span vibration, as well as other noise, vibration and harshness problems. However, the friction damping of a tensioner has a certain limitation dictated by system requirements, tensioner tension, belt life and tensioner size. Because of the tensioner's limit of friction damping, there are some IC engines where a mechanical tensioner alone is not capable of properly controlling belt tensions and consequently they are unable to eliminate vibration and noise problems from a belt drive.

Representative of the art is U.S. Pat. No. 7,021,271 which discloses a belt drive system can appropriately transmit power of an electric rotating machine without setting initial belt tension to be large. In the belt drive system, a stationary tension pulley 18 is located on the side opposite to a crank pulley with respect to an electric rotating machine pulley 13 so that contact angle of a belt that is wrapped around the electric rotating machine pulley 13 in contact therewith may be in a range of 130.degree. to 230.degree.; an idle pulley 17a of a first stopper-equipped auto-tensioner 17 is located between the electric rotating machine pulley 13 and an internal combustion engine crank pulley 2; and position of the idle pulley 17a is fixed at the time of starting an internal combustion engine; while the idle pulley 17a coming to be movable at the time of driving the electric rotating machine as a generator.

What is needed is a belt drive system having a tensioner, an idler, and a short effective length arm idler engaging the belt immediately preceding the driver pulley. The present invention meets this need.

### SUMMARY OF THE INVENTION

The primary aspect of the invention is to provide a belt drive system having a tensioner, an idler, and a short effective length arm idler engaging the belt immediately preceding the driver pulley.

Other aspects of the invention will be pointed out or made obvious by the following description of the invention and the accompanying drawings.

The invention comprises a belt system comprising a driver pulley, a driven pulley, a belt trained between the driver pulley and the driven pulley, a belt tensioning device engaged with the belt, a first idler engaged with the belt between the driver pulley and the driven pulley, a second idler engaged with the belt, the second idler engaged with the belt span immediately upstream of the driver pulley, the second idler comprising an arm journalled to a base, the arm urged to load the belt by a torsion spring, the arm having an effective length of less than 6 mm, and the torsion spring having a spring rate of approximately 0.128 mm/deg.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a schematic of a belt drive system.

FIG. 2 is a graph showing belt load versus arm position.

FIG. 3 is a perspective view of an inventive idler.

FIG. 4 is a cross-sectional view of an inventive idler.

FIG. 5 is a bottom perspective view of an inventive idler.

FIG. 6A is a graph showing hubload for the air conditioner compressor pulley versus speed for a belt system not using the inventive idler.

FIG. 6B is a graph showing hubload for the alternator pulley versus speed for a belt system not using the inventive idler.

FIG. 6C is a graph showing hubload for the air conditioner compressor pulley versus speed for a belt system using the inventive idler.

FIG. 6D is a graph showing hubload for the alternator pulley versus speed for a belt system using the inventive idler.

FIG. 7A is a graph showing tensioner arm movement versus speed for a belt system not using the inventive idler.

FIG. 7B is a graph showing peak to peak tensioner arm movement versus speed for a belt system not using the inventive idler.

FIG. 7C is a graph showing angular arm displacement versus speed for a belt system not using the inventive idler.

FIG. 7D is a graph showing tensioner arm acceleration versus speed for a belt system not using the inventive idler.

FIG. 8A is a graph showing tensioner arm movement versus speed for a belt system using the inventive idler.

FIG. 8B is a graph showing peak to peak tensioner arm movement versus speed for a belt system using the inventive idler.

FIG. 8C is a graph showing angular arm displacement versus speed for a belt system using the inventive idler.

FIG. 8D is a graph showing tensioner arm acceleration versus speed for a belt system using the inventive idler.

### DETAILED DESCRIPTION OF THE PREFERRED EMBODIMENT

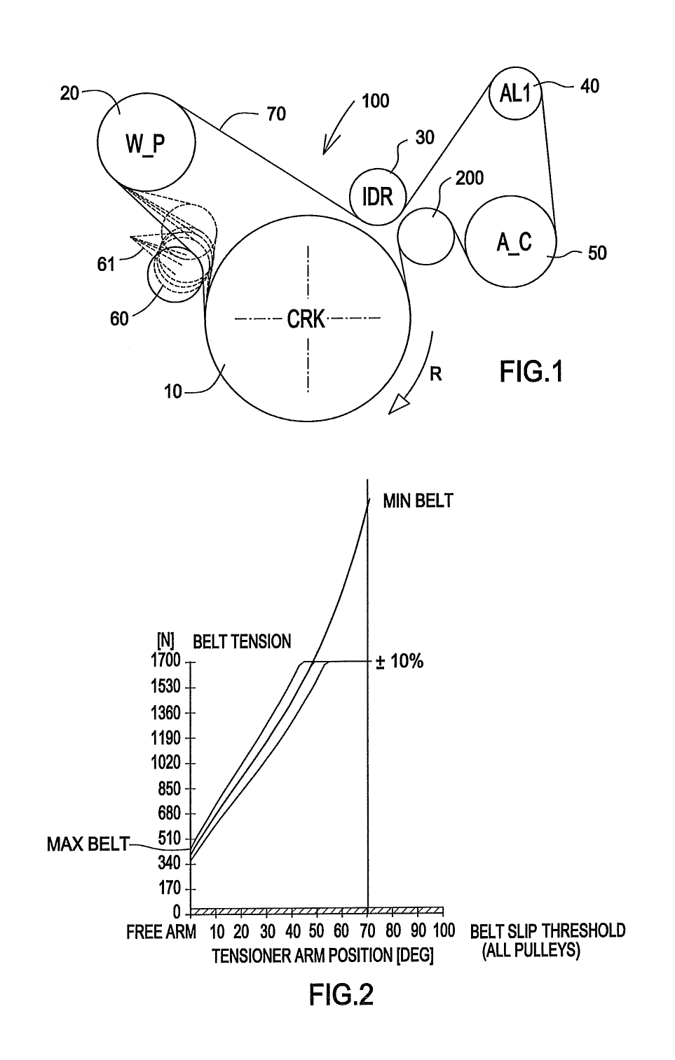

FIG. 1 is a schematic of a belt drive system. The belt drive system 100 comprises a crankshaft pulley 10. The system also comprises a water pump pulley 20, an idler 30, an alternator pulley 40 and an air conditioner compressor pulley 50. A belt 70 is entrained between the pulleys. Idler 30 comprises a pulley journalled to a shaft as is known in the art.

A tensioner 60 applies a belt load to belt 70. The belt load ensures proper engagement between belt 70 and the noted pulleys. Tensioner 60 is known in the art and may comprise a pivot arm 61 loaded by a torsion spring (not shown). Tensioner 60 is located on the “slack” side of the crankshaft pulley. This is potion of the belt immediately downstream of the crankshaft pulley in the rotational direction (R).

An inventive idler 200 engages belt 70 on the “tight” side of crankshaft pulley 10. Crankshaft pulley rotates in direction (R). Idler 200 is engaged with the belt span immediately upstream of the crankshaft (driver) pulley. All other pulleys are driven by the crankshaft pulley.

Idler 200 reduces the dynamic behavior of the belt drive. Idler 200 has a very short arm length in combination with a very a high angle spring curve. Idler 200 is installed on the tight side belt span and the range of the idler hubload ranges from under the basic hubload created solely by belt tensioner 60 up to the hubload which occurs when all components load the belt. Idler 200 reduces the dynamic loads in the belt drive system and eliminates zero loads on all of the components.

FIG. 2 is a graph showing belt load versus arm position. The “y” axis of the graph is a belt load in Newtons. The “X” axis is idler arm position in degrees. As shown by the graph, the belt load steeply increases as the idler arm rotates.

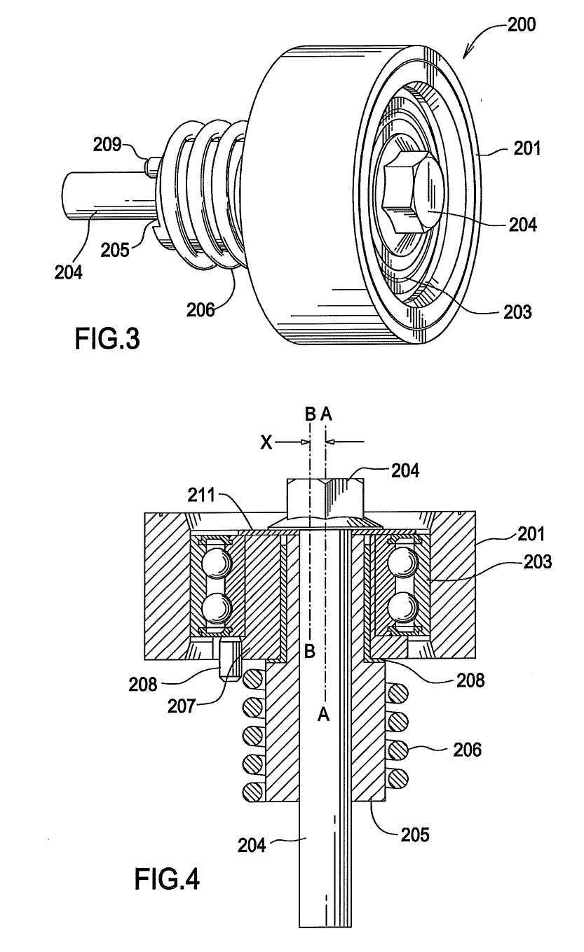

FIG. 3 is a perspective view of an inventive idler. Idler 200 comprises a pulley 201 for engaging a belt. Pulley 201 is journalled to arm 207. Arm 207 pivots about base 205. Bolt 204 fixes base 205 to a mounting surface. Bushing 208 facilitates pivotal movement of arm 207 about base 205.

Torsion spring 206 urges arm 207 into engagement with belt 70. The torsion spring preload is 1.5 mm and the spring rate is 0.128 mm/deg. From free arm to free spring is 11.7 deg. The maximum arm angle range is 70 degrees for all load conditions.

FIG. 4 is a cross-sectional view of an inventive idler. Torsion spring 206 engages arm 207 about pin 208.

The centerline of belt 204 is A-A. The axis of rotation of arm 207 is B-B. B-B is offset (X) from A-A is preferably equal to or less than 3.5 mm for the inventive idler. Dimension (X) may be up to 6 mm for the inventive idler. The offset (X) is also referred to as the effective length.

A washer 211 retains arm 207 and bushing 208 on base 205.

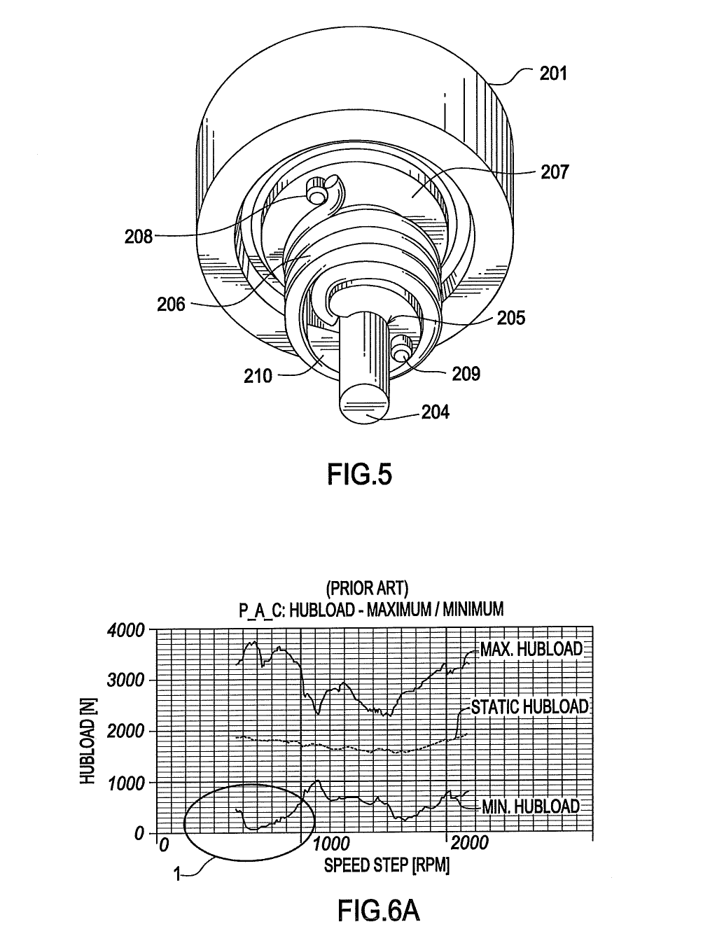

FIG. 5 is a bottom perspective view of an inventive idler. Torsion spring 206 engages arm 207 about pin 208. Torsion spring 206 engages base 205 at a slot 210. A pin 209 prevents rotation of base 205.

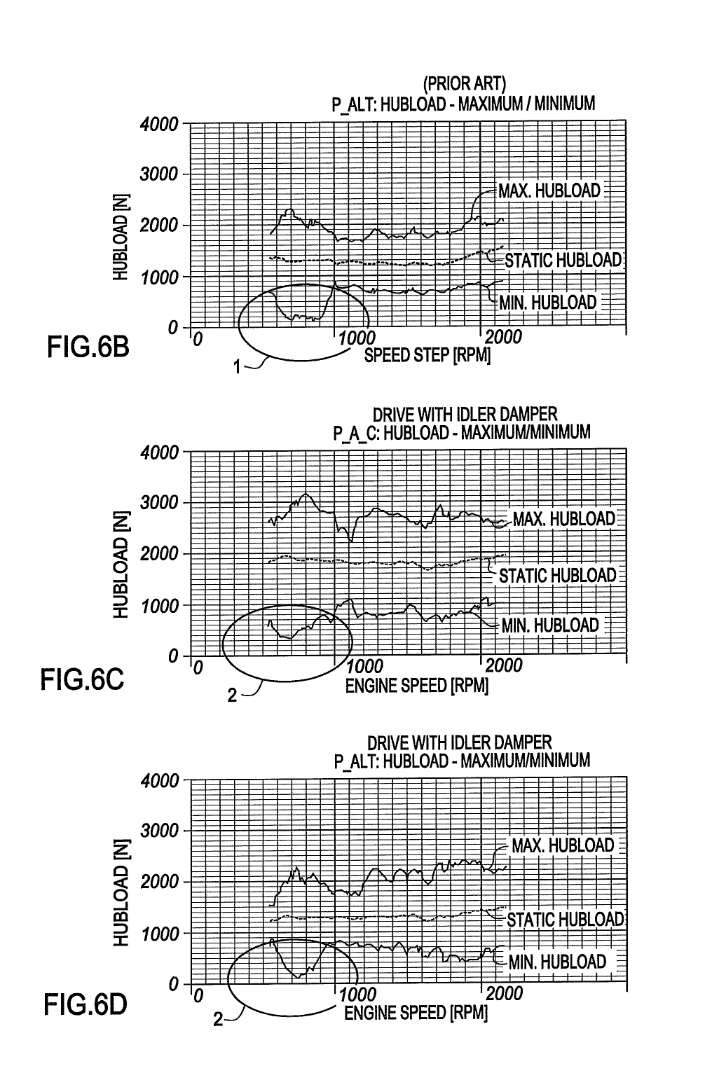

FIG. 6A is a graph showing hubload for the air conditioner compressor pulley versus speed for a belt system not using the inventive idler. The minimum hubload for the belt system using the idler is less (See “1”, FIGS. 6A-6B) when compared to the hubload minimum for the system not using the inventive idler (See “2”, FIGS. 6C-6D). “Max. hubload” refers to maximum tensioner hubload during operation. “Min. hubload” refers to minimum tensioner hubload during operation. “Static hubload” refers to the tensioner hubload when the system is not in operation. Each of these definitions also applies to FIGS. 6B, 6C and 6D.

FIG. 6B is a graph showing hubload for the alternator pulley versus speed for a belt system not using the inventive idler.

FIG. 6C is a graph showing hubload for the air conditioner compressor pulley versus speed for a belt system using the inventive idler.

FIG. 6D is a graph showing hubload for the alternator pulley versus speed for a belt system using the inventive idler.

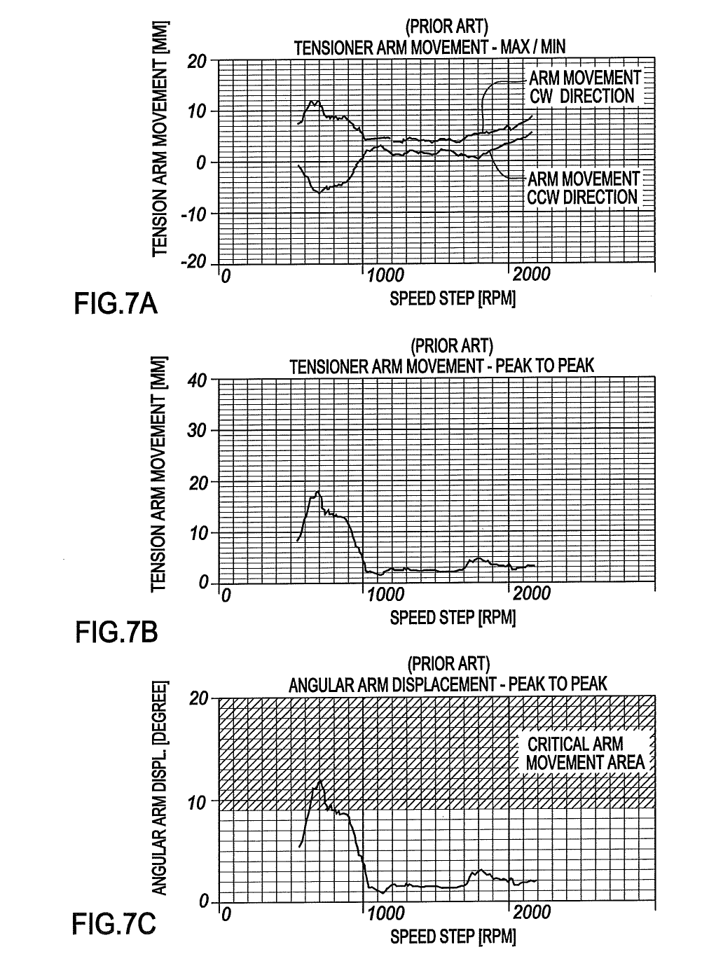

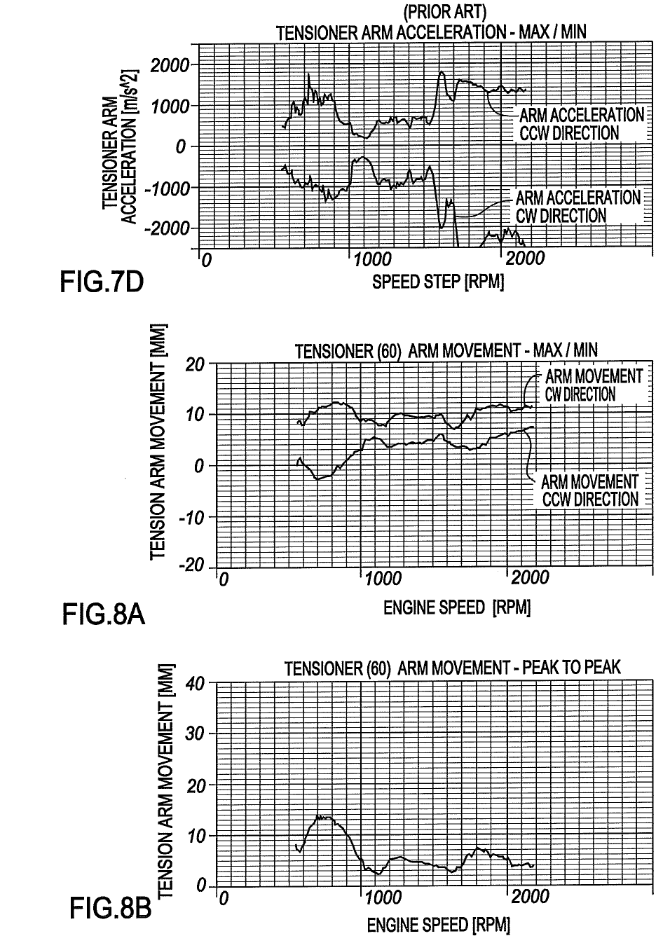

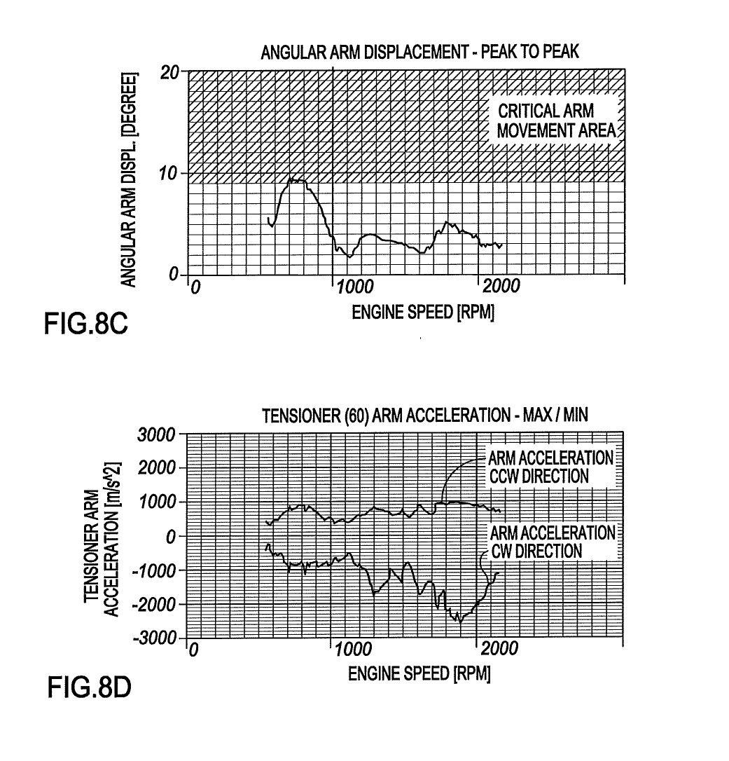

FIG. 7A is a graph showing tensioner arm movement versus speed for a belt system not using the inventive idler. FIG. 7A indicates greater tensioner arm (61, see FIG. 1) movement when compared to FIG. 8A. This is also the case for FIG. 7B compared to FIG. 8B, and for FIG. 7C compared to FIG. 8C. The acceleration in FIG. 7D is reduced in FIG. 8D, again illustrating the advantages of the belt system using an inventive idler 200. “CW” refers to clockwise and “CCW” refers to counter-clockwise.

FIG. 7B is a graph showing peak to peak tensioner arm movement versus speed for a belt system not using the inventive idler.

FIG. 7C is a graph showing angular arm displacement versus speed for a belt system not using the inventive idler. “Critical arm movement area” refers to tensioner arm (61) displacement in excess of nine degrees for all system speeds.

FIG. 7D is a graph showing tensioner arm acceleration versus speed for a belt system not using the inventive idler.

FIG. 8A is a graph showing tensioner arm movement versus speed for a belt system using the inventive idler.

FIG. 8B is a graph showing peak to peak tensioner arm movement versus speed for a belt system using the inventive idler.

FIG. 8C is a graph showing angular arm displacement versus speed for a belt system using the inventive idler.

FIG. 8D is a graph showing tensioner arm acceleration versus speed for a belt system using the inventive idler.

The belt system using the inventive idler demonstrates a reduction in the tensioner arm movement max/min, peak to peak tensioner arm movement, angular displacement peak to peak and acceleration when compared to a belt system not using the inventive idler. Reduction or moderation of each of these characteristics improves belt system performance and enhances the operating life of the belt system and its components.

Although a form of the invention has been described herein, it will be obvious to those skilled in the art that variations may be made in the construction and relation of parts and method without departing from the spirit and scope of the invention described herein.

We claim:

1. A belt system comprising:
a driver pulley;
a driven pulley;
a belt trained between the driver pulley and the driven pulley;
a belt tensioning device engaged with the belt;
a first idler engaged with the belt between the driver pulley and the driven pulley;
a second idler engaged with the belt, the second idler engaged with the belt span immediately upstream of the driver pulley;
the second idler comprising an arm journalled to a base, the arm urged to load the belt by a torsion spring;
the arm having an effective length of less than 6 mm; and
the torsion spring having a spring rate of approximately 0.128 mm/deg.

2. The belt drive system as in claim 1, wherein the driver pulley is fixed to a crankshaft.

3. The belt drive system as in claim 1, wherein the belt tensioning device is on the slack side of the belt with respect to the driver pulley.

4. The belt drive system as in claim 1, wherein the belt tensioning device comprises a pivot arm.

5. The belt drive system as in claim 1, wherein the arm has an effective length of less than 3.5 mm.

6. A belt system comprising:
a driver pulley fixed to a crankshaft;
a driven pulley;
a belt trained between the driver pulley and the driven pulley;
a belt tensioning device engaged with the belt on the slack side of the belt with respect to the driver pulley;
a first idler engaged with the belt between the driver pulley and the driven pulley;
a second idler engaged with the belt, the second idler engaged with the belt span immediately upstream of the driver pulley;
the second idler comprising an arm pivotably journalled to a base, the arm urged to load the belt by a torsion spring;
the arm having an effective length of less than 3.5 mm; and
the torsion spring having a spring rate of greater than 0.128 mm/deg.

7. A belt system comprising:
a driver pulley fixed to a crankshaft;
a driven alternator pulley;
a belt trained between the driver pulley and the driven alternator pulley;
a belt tensioning device having a pivot arm, the belt tensioning device engaged with the belt on the slack side of the belt with respect to the driver pulley;
a first idler engaged with the belt between the belt tensioning device and the driven alternator pulley;
a second idler engaged with the belt, the second idler engaged with the belt span immediately upstream of the driver pulley;
the second idler comprising an arm pivotably journalled to a base, the arm urged to load the belt by a torsion spring;
the arm having an effective length of equal to or less than 3.5 mm; and
the torsion spring having a spring rate of greater than 0.128 mm/deg.
